(19) United States
(12) Patent Application Publication
(10) Pub. No.: US 2007/0038781 A1
(43) Pub. Date: Feb. 15, 2007

(54) Apparatus and method for converting contents

(76) Inventors: Ye-Sun Joung, Daejon (KR); Sang-Woo Ahn, Daejon (KR); Kyu-Heon Kim, Daejon (KR)

Correspondence Address: LADAS & PARRY LLP, 224 SOUTH MICHIGAN AVENUE, SUITE 1600, CHICAGO, IL, 60604, US

(21) Appl. No.: 11/543,179

(22) Filed: Oct. 4, 2006

(30) Foreign Application Priority Data
Aug. 12, 2005 (KR) 10-2005-0119678
Apr. 19, 2006 (KR) 10-2006-0035300

(51) Int. Cl. G06F 15/16

(52) U.S. Cl. 709/246

(57) ABSTRACT

Provided is an apparatus and method for converting contents. The apparatus includes: a contents input unit for receiving contents for digital television (DTV) broadcasting; a decompiling unit for analyzing a class file of the contents for DTV broadcasting transmitted from the contents input unit and creating common contents conversion information and contents conversion information; a contents converting unit for converting the contents for DTV broadcasting transmitted from the contents input unit based on the created common contents conversion information; and an eXtensible MPEG-4 Textual format (XMT) creating unit for applying the contents conversion information to a template file from outside and creating XMT.

### FIELD OF THE INVENTION

The present invention relates to an apparatus and method for converting contents; and, more particularly, to an apparatus and method for converting contents for terrestrial digital TV (DTV) broadcasting into contents for terrestrial Digital Multimedia Broadcasting (DMB).

### DESCRIPTION OF RELATED ART

Although the present invention will be described under assumption that contents for digital TV (DTV) are contents of Advanced Common Application Platform (ACAP), which is as a data broadcasting standard, the invention is not limited to ACAP contents.

Amongst increasing demands for mobile multimedia services, a terrestrial Digital Multimedia Broadcasting (DMB) service is commercialized. Accordingly, a good quality and differentiation of a service are required to acquire an enough demand and marketability. That is, a service for contents which go beyond a simple entertainment purpose of audio/video (A/V) and are valuable as information is required in a current broadcasting service market where desire for acquiring information is generalized. Accordingly, an additional data service is required as well as the basic AV service.

Although a terrestrial DMB service becomes commercialized, it is quite early to be optimistic whether the terrestrial DMB service is successful in a digital industrial market. In consideration of a reality that supply and progress of a terrestrial DTV, an additional data service which is valuable as information is necessary in addition to the AV service of a high definition and high sound quality for commercial success of the terrestrial DMB.

Accordingly, data broadcasting can be an important key for predicting the commercial success of the terrestrial DMB and research on the contents for the data broadcasting service of DMB becomes very meaningful.

Also, in consideration of circumstances that there has been no research on contents conversion in Korea and other countries and that a DMB technology has been developed comparatively further than DTV broadcasting technology, it is very important to develop a technology for the contents conversion.

Generally, data broadcasting of the terrestrial DMB is basically performed by re-transmitting contents for DTV broadcasting. Since there is a difference between a contents standard and a service standard of the data broadcasting, a format of the ACAP contents should be converted to provide contents of the ACAP format, which is a data broadcasting standard provided in the terrestrial DTV, through a DMB system.

### SUMMARY OF THE INVENTION

It is, therefore, an object of the present invention to provide an apparatus and method for converting contents for terrestrial digital television (DTV) broadcasting into contents for terrestrial Digital Multimedia Broadcasting (DMB).

It is another object of the present invention to provide an apparatus and method for converting contents of Advanced Common Application Platform (ACAP) format, which is a terrestrial digital TV data broadcasting standard, into a DMB data broadcasting standard.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided an apparatus for converting contents, the apparatus including: a contents input unit for receiving contents for digital television (DTV) broadcasting; a decompiling unit for analyzing a class file of the contents for DTV broadcasting transmitted from the contents input unit and creating common contents conversion information and contents conversion information; a contents converting unit for converting the contents for DTV broadcasting transmitted from the contents input unit based on the created common contents conversion information; and an extensible MPEG-4 Textual format (XMT) creating unit for applying the contents conversion information to a template file from outside and creating XMT.

In accordance with another aspect of the present invention, there is provided a method for converting contents, the method including the steps of: a) receiving contents for digital TV broadcasting; b) analyzing a class file of the inputted contents for DTV broadcasting and creating common contents conversion information and contents conversion information; c) converting the inputted contents for DTV broadcasting based on the created common contents conversion information; and d) applying the created contents conversion information to a template file and creating an extensible MPEG-4 Textual format (XMT).

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing an apparatus for converting contents in accordance with an embodiment of the present invention; and

FIG. 2 is a flowchart describing a method for converting contents in accordance with an embodiment of the present invention.

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

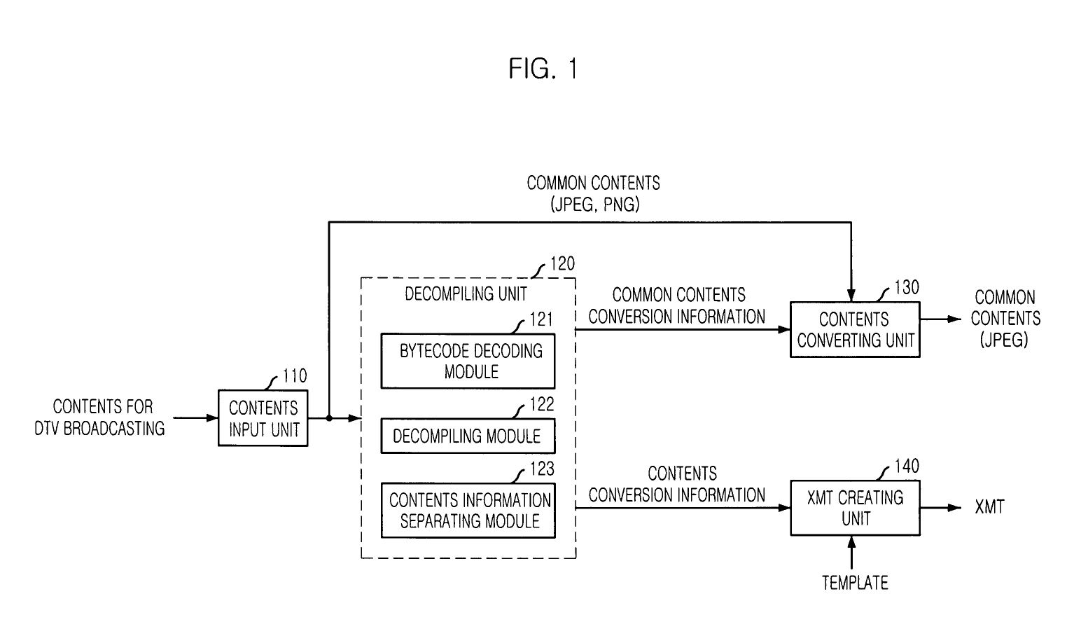

FIG. 1 is a block diagram showing an apparatus for converting contents in accordance with an embodiment of the present invention. To be specific, FIG. 1 shows an apparatus for converting contents for digital television (DTV) broadcasting into contents for terrestrial Digital Multimedia Broadcasting (DMB).

The contents converting apparatus of the present invention includes a contents input unit 110, a decompiling unit 120, a contents converting unit 130, and an extensible MPEG-4 Textual format (XMT) creating unit 140.

The contents input unit 110 receives the contents for DTV broadcasting.

The decompiling unit 120 analyzes a class file of the contents for DTV broadcasting transmitted from the contents input unit 110 and creates common contents conversion information and contents conversion information.

The contents converting unit 130 converts the contents for DTV broadcasting transmitted from the contents input unit 110 based on the common contents conversion information created in the decompiling unit 120.

The XMT creating unit 140 applies the contents conversion information created in the decompiling unit 120 to a template file from outside and creates the XMT.

The contents converting apparatus further includes a DMB contents creating unit (not shown) for creating DMB contents based on the common contents converted in the contents converting unit 130 and XMT created in the XMT creating unit 140.

The contents input unit 110 receives contents for DTV broadcasting from external apparatus and transmits the contents for DTV broadcasting to the decompiling unit 120 and the contents converting unit 130. When the data broadcasting contents among contents for DTV broadcasting are Java based-contents (ACAP-J:Java), the contents include a Java class and common contents. A case that the inputted contents for DTV broadcasting is the ACAP-J will be described as an example.

The decompiling unit 120 analyzes a class file format of the ACAP-J contents outputted from the contents input unit 110, decodes a bytecode, creates and outputs common contents conversion information to the contents converting unit 130.

It is required to convert a format, a size and a location of the contents to convert the contents for DTV broadcasting to the DMB contents. For example, when the contents for DTV broadcasting is an image file of a portable network graphics (PNG) format, which is a compressed graphic image file format, the PNG file should be converted into the JPEG file and a size of the image should be converted to display the image on small screen of a terminal for DMB since the DMB supports only a Joint Photographic Experts Group (JPEG) file. In case of location conversion, the location conversion information is designated in a template to be described hereinafter.

The decompiling unit 120 analyzes ACAP-J contents outputted from the contents input unit 110. When the common contents are the PNG file, the decompiling unit 120 outputs format and size conversion information as common contents conversion information to the contents converting unit 130. When the common contents are the JPEG file, the decompiling unit 120 outputs size conversion information as common contents conversion information to the contents converting unit 130.

Also, the decompiling unit 120 analyzes the Java class of the ACAP-J contents outputted from the contents input unit 110, creates contents conversion information required for an extensible MPEG-4 Textual format (XMT) for forming DMB contents and transmits the contents conversion information to the XMT creating unit 140.

As shown in FIG. 1, the decompiling unit 120 includes a bytecode decoding module 121, a decompiling module 122 and a contents information separating module 123.

The bytecode decoding module 121 receives the class files included in the ACAP-J contents and analyzes a class file format to decode the bytecode.

The decompiling module 122 converts the class files analyzed in the bytecode decoding module 121 into a Java virtual machine assembly command.

The contents information separating module 123 separates information for creating DMB contents based on the Java virtual machine assembly commands converted in the decompiling module 122 and creates common contents conversion information and contents conversion information.

The contents converting unit 130 receives the common contents among the contents for DTV broadcasting outputted in the contents input unit 110 and the common contents conversion information outputted in the decompiling unit 120, and converts a size and a format of the common contents based on the command contents conversion information. For example, the size and the format of the common contents are converted in conformity to a DMB standard based on a file name of the common contents analyzed in the decompiling unit 120.

The XMT creating unit 140 receives contents conversion information outputted in the decompiling unit 120 and a template including location conversion information from outside, and creates an XMT file. The contents conversion information includes node information, graphic object information, and event information, which are required for scene organization. The template is the XMT file created based on scene organization information generally used according to the DTV contents.

The XMT is a framework for describing an MPEG-4 scene technology and an object technology in a text form. Since the XMT is described in a text form, it is easy to exchange contents between contents writers and possible to use a non-decoded audio/video object in contents work. Also, information for coding the audio/video object can be individually stored.

The XMT creating unit 140 receives contents conversion information extracted from the ACAP-J contents in the decompiling unit 120, applies the contents conversion information to the template file and creates a final XMT file.

The present invention can easily extract only information to be actually used by creating XMT based on the contents conversion information.

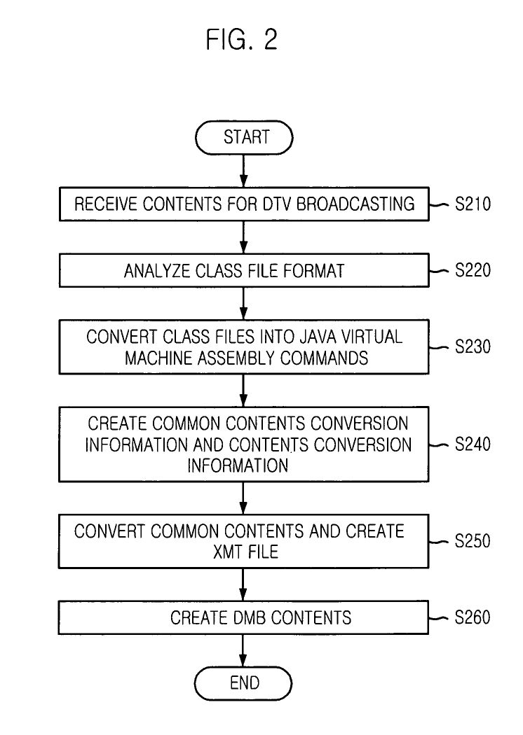

FIG. 2 is a flowchart describing a method for converting contents in accordance with an embodiment of the present invention. It shows a method for converting contents for DTV broadcasting into DMB contents.

When the contents for DTV broadcasting are transmitted from the contents input unit 110 at step S210, the decompiling unit 120 analyzes a class file format at step S220.

The decompiling unit 120 converts the analyzed class files into the Java virtual machine assembly command at step S230.

The decompiling unit 120 separates information for creating DMB contents based on the converted Java virtual machine assembly command, and creates common contents conversion information and contents conversion information at step S240.

When the contents converting unit 130 converts the inputted common contents based on the created common contents conversion information and the XMT creating unit 140 applies the created contents conversion information to the template file, an XMT file is created at step S250.

DMB contents can be created based on the converted common contents and the created XMT at step S260.

As described above, the present invention can convert the contents for terrestrial DTV broadcasting into the DMB contents.

That is, the present invention can convert the contents of the ACAP format, which is the terrestrial DTV data broadcasting standard, into the terrestrial DMB data broadcasting standard.

As described in detail, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent application Nos. 2005-0119678 and 2006-0035300 filed with the Korean Intellectual Property Office on Dec. 8, 2005, and Apr. 19, 2006, respectively, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An apparatus for converting contents, comprising:
a contents input means for receiving contents for digital television (DTV) broadcasting;
a decompiling means for analyzing a class file of the contents for DTV broadcasting transmitted from the contents input means and creating common contents conversion information and contents conversion information;
a contents converting means for converting the contents for DTV broadcasting transmitted from the contents input means based on the created common contents conversion information; and
an extensible MPEG-4 Textual format (XMT) creating means for applying the contents conversion information to a template file from outside and creating XMT.

2. The apparatus as recited in claim 1, further comprising:
a Digital Multimedia Broadcasting (DMB) contents creating means for creating DMB contents based on the converted common contents and the created XMT.

3. The apparatus as recited in claim 1, wherein the decompiling means analyzes a class file format of Advanced Common Application Platform (ACAP) contents outputted from the contents input means, decodes a bytecode, creates common contents conversion information, outputs the common contents conversion information to the contents converting means, creates contents conversion information required for the XMT for forming the DMB contents, and transmits the contents conversion information to the XMT creating means.

4. The apparatus as recited in claim 3, wherein the decompiling means includes:
a bytecode decoding module for receiving and analyzing class files included in the ACAP contents to figure out a class file format for bytecode decoding;
a decompiling module for converting the class files analyzed in the bytecode decoding module into Java virtual machine assembly commands; and
a contents information separating module for separating information for creating DMB contents based on the converted Java virtual machine assembly commands and creating common contents conversion information and contents conversion information.

5. The apparatus as recited in claim 4, wherein the decompiling means analyzes the ACAP contents transmitted from the contents input means, outputs format and size conversion information as common contents conversion information to the contents converting means when the common contents are a portable network graphics (PNG) file, and outputs size conversion information as common contents conversion information to the contents converting means when the common contents are a Joint Photographic Experts Group (JPEG) file.

6. A method for converting contents, comprising the steps of:
a) receiving contents for digital television (DTV) broadcasting;
b) analyzing a class file of the inputted contents for DTV broadcasting and creating common contents conversion information and contents conversion information;
c) converting the inputted contents for DTV broadcasting based on the created common contents conversion information; and
d) applying the created contents conversion information to a template file and creating an extensible MPEG-4 Textual format (XMT).

7. The method as recited in claim 6, further comprising the step of:
e) creating Digital Multimedia Broadcasting (DMB) contents based on the converted common contents and the created XMT.

8. The method as recited in claim 6, wherein the step b) includes:
b1) analyzing a format of the class file included in the inputted contents for DTV broadcasting;
b2) converting the analyzed class files into Java virtual machine assembly commands; and
b3) separating information for creating DMB contents based on the converted Java virtual machine assembly command and creating common contents conversion information and contents conversion information.

9. The method as recited in claim 8, wherein the inputted contents for DTV broadcasting are Advanced Common Application Platform (ACAP) contents.
